(19) United States
(12) Patent Application Publication
(10) Pub. No.: US 2023/0009479 A1
(43) Pub. Date: Jan. 12, 2023

(54) INFORMATION PROCESSING APPARATUS, INFORMATION PROCESSING SYSTEM, INFORMATION PROCESSING METHOD, AND PROGRAM

(71) Applicant: SONY GROUP CORPORATION, TOKYO (JP)

(72) Inventors: YUSUKE SUZUKI, TOKYO (JP); TAKAHIRO KOYAMA, TOKYO (JP)

(21) Appl. No.: 17/780,381

(22) PCT Filed: Nov. 19, 2020
(86) PCT No.: PCT/JP2020/043215

§ 371 Date: May 26, 2022

(30) Foreign Application Priority Data
Dec. 5, 2019 (JP) 2019-220579

(51) Int. Cl. G06V 20/58; G06V 10/25; G06V 10/26; B60W 40/04

(52) U.S. Cl. CPC G06V 20/58; G06V 10/25; G06V 10/26; B60W 40/04; G06V 2201/07; B60W 2420/42; B60W 2554/4042

(57) ABSTRACT

To provide a technology that makes it possible to recognize a target object quickly and accurately. An information processing apparatus according to the present technology includes a controller. The controller recognizes a target object on the basis of event information that is detected by an event-based sensor, and transmits a result of the recognition to a sensor apparatus that includes a sensor section that is capable of acquiring information regarding the target object.

### TECHNICAL FIELD

The present technology relates to a technology used to recognize a target object to, for example, control automated driving.

### BACKGROUND ART

The level of automated driving of an automobile is classified into six stages that are Level 0 to Level 5, and automobiles are expected to be developed in stages from manually driving at Level 0 to fully automated driving at Level 5. Technologies up to partially automated driving at Level 2 have already been put into practical use, and conditionally automated driving at Level 3, which is a next stage, is in the process of being put into practical use.

In the automated driving control, there is a need to recognize the environment (such as another vehicle, a human, a traffic light, and a traffic sign) around an own vehicle. Various sensors such as a camera, light detection and ranging (lidar), a millimeter-wave radar, and an ultrasonic sensor are used to perform sensing with respect to the environment around the own vehicle.

Patent Literature 1 indicated below discloses a technology used to monitor, using an event-based (visual) sensor, a road surface on which a vehicle intends to travel. The event-based sensor is a sensor that can detect a change in brightness for each pixel. At the timing of the occurrence of a change in brightness in a portion, the event-based sensor can only output information regarding the portion.

Here, an ordinary image sensor that outputs an overall image at a fixed frame rate is also referred to as a frame-based sensor, and a sensor of the type described above is referred to as an event-based sensor, by comparison with the frame-based sensor. A change in brightness is captured by the event-based sensor as an event.

### CITATION LIST

### Patent Literature

Patent Literature 1: Japanese Patent Application Laid-open No. 2013-79937

### DISCLOSURE OF INVENTION

### Technical Problem

In such a field, there is a need for a technology that makes it possible to recognize a target object quickly and accurately.

In view of the circumstances described above, it is an object of the present technology to provide a technology that makes it possible to recognize a target object quickly and accurately.

### Solution to Problem

An information processing apparatus according to the present technology includes a controller.

The controller recognizes a target object on the basis of event information that is detected by an event-based sensor, and transmits a result of the recognition to a sensor apparatus that includes a sensor section that is capable of acquiring information regarding the target object.

Consequently, for example, a target object recognized using event information can be recognized quickly and accurately by acquiring, from the sensor apparatus, information regarding a portion that corresponds to the target object.

In the information processing apparatus, the controller may recognize the target object, may specify a region-of-interest (ROI) location that corresponds to the target object, and may transmit the ROI location to the sensor apparatus as the result of the recognition.

In the information processing apparatus, the sensor apparatus may cut ROI information corresponding to the ROI location out of information that is acquired by the sensor section, and may transmit the ROI information to the information processing apparatus.

In the information processing apparatus, the controller may recognize the target object on the basis of the ROI information acquired from the sensor apparatus.

In the information processing apparatus, the controller may design an automated driving plan on the basis of information regarding the target object recognized on the basis of the ROI information.

In the information processing apparatus, the controller may design the automated driving plan on the basis of information regarding the target object recognized on the basis of the event information.

In the information processing apparatus, the controller may determine whether the automated driving plan is designable only on the basis of the information regarding the target object recognized on the basis of the event information.

In the information processing apparatus, when the controller has determined that the automated driving plan is not designable, the controller may acquire the ROI information, and may design the automated driving plan on the basis of the information regarding the target object recognized on the basis of the ROI information.

In the information processing apparatus, when the controller has determined that the automated driving plan is designable, the controller may design, without acquiring the ROI information, the automated driving plan on the basis of the information regarding the target object recognized on the basis of the event information.

In the information processing apparatus, the sensor section may include an image sensor that is capable of acquiring an image of the target object, and the ROI information may be a ROI image.

In the information processing apparatus, the sensor section may include a complementary sensor that is capable of acquiring complementary information that is information regarding a target object that is not recognized by the controller using the event information.

In the information processing apparatus, the controller may acquire the complementary information from the sensor apparatus, and on the basis of the complementary information, the controller may recognize the target object not being recognized using the event information.

In the information processing apparatus, the controller may design the automated driving plan on the basis of information regarding the target object recognized on the basis of the complementary information.

In the information processing apparatus, the controller may acquire information regarding a movement of a movable object, the movement being a target of the automated driving plan, and on the basis of the information regarding the movement, the controller may change a period with which the target object is recognized on the basis of the complementary information.

In the information processing apparatus, the controller may make the period shorter as the movement of the movable object becomes slower.

In the information processing apparatus, the sensor apparatus may modify a cutout location for the ROI information on the basis of an amount of misalignment of the target object in the ROI information.

An information processing system according to the present technology includes an information processing apparatus and a sensor apparatus. The information processing apparatus includes a controller. The controller recognizes a target object on the basis of event information that is detected by an event-based sensor, and transmits a result of the recognition to a sensor apparatus that includes a sensor section that is capable of acquiring information regarding the target object.

An information processing method according to the present technology includes recognizing a target object on the basis of event information that is detected by an event-based sensor; and transmitting a result of the recognition to a sensor apparatus that includes a sensor section that is capable of acquiring information regarding the target object.

A program according to the present technology causes a computer to perform a process including recognizing a target object on the basis of event information that is detected by an event-based sensor; and transmitting a result of the recognition to a sensor apparatus that includes a sensor section that is capable of acquiring information regarding the target object.

### BRIEF DESCRIPTION OF DRAWINGS

FIG. 1 illustrates an automated-driving control system according to a first embodiment of the present technology.

FIG. 2 is a block diagram illustrating an internal configuration of the automated-driving control system.

FIG. 3 illustrates a state in which a vehicle that includes a DVS is traveling on an ordinary road.

FIG. 4 illustrates information regarding an edge of a vehicle ahead that is acquired by the DVS.

FIG. 5 illustrates an image of the vehicle ahead that is acquired by an image sensor.

FIG. 6 is a flowchart illustrating processing performed by a controller of an automated-driving control apparatus.

FIG. 7 is a flowchart illustrating processing performed by a controller of a sensor apparatus.

FIG. 8 illustrates a state in which a recognition model is generated.

FIG. 9 illustrates an example of a specific block configuration in the automated-driving control system.

FIG. 10 illustrates another example of the specific block configuration in the automated-driving control system.

### MODE(S) FOR CARRYING OUT THE INVENTION

Embodiments according to the present technology will now be described below with reference to the drawings.

<<First Embodiment>>

<Overall Configuration and Configuration of Each Structural Element>

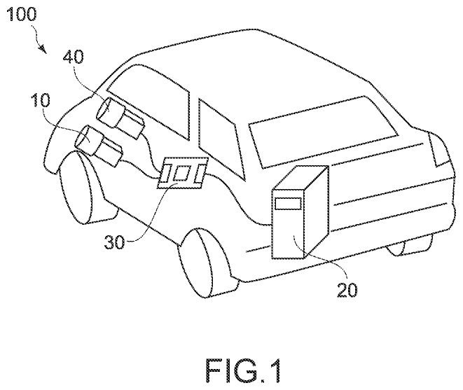

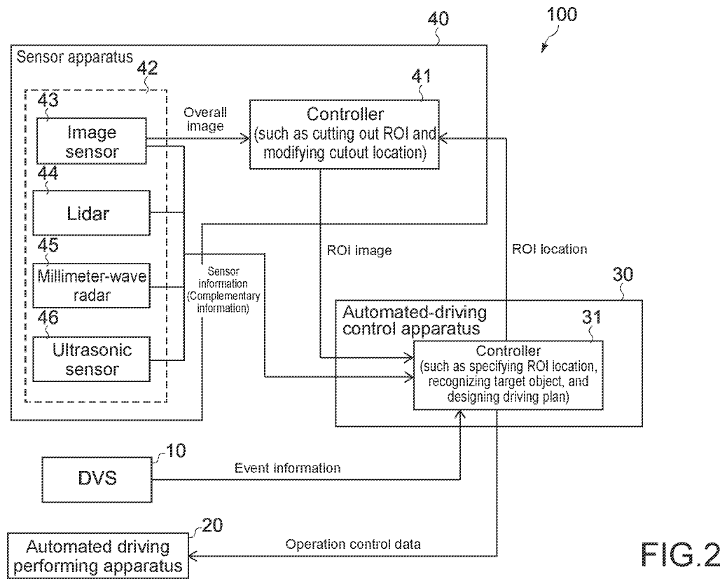

FIG. 1 illustrates an automated-driving control system 100 according to a first embodiment of the present technology. FIG. 2 is a block diagram illustrating an internal configuration of the automated-driving control system 100.

An example in which the automated-driving control system 100 (an information processing system) is included in an automobile to control driving of the automobile is described in the first embodiment. Note that a movable object (regardless of whether the movable object is manned or unmanned) that includes the automated-driving control system 100 is not limited to an automobile, and may be, for example, a motorcycle, a train, an airplane, or a helicopter.

As illustrated in FIGS. 1 and 2, the automated-driving control system 100 according to the first embodiment includes a dynamic vision sensor (DVS) 10, a sensor apparatus 40, an automated-driving control apparatus (an information processing apparatus) 30, and an automated driving performing apparatus 20. The automated-driving control apparatus 30 can communicate with the DVS 10, the sensor apparatus 40, and the automated driving performing apparatus 20 by wire or wirelessly.

[DVS]

The DVS 10 is an event-based sensor. The DVS 10 can detect, for each pixel, a change in the brightness of incident light. At the timing of the occurrence of a change in the brightness in a portion corresponding to a pixel, the DVS 10 can output coordinate information and corresponding time information, the coordinate information being information regarding coordinates that represent the portion. The DVS 10 generates, on the order of microseconds, time-series data that includes the coordinate information related to a change in brightness, and transmits the data to the automated-driving control apparatus 30. Note that the time-series data being acquired by the DVS 10 and including coordinate information related to a change in brightness is hereinafter simply referred to as event information.

Since the DVS 10 only outputs information regarding a portion in which there is a change in brightness, a data amount is smaller and an output speed is higher (on the order of microseconds), compared to the case of an ordinary image sensor based on a frame. Further, the DVS 10 performs a log-scale output, and has a wide dynamic range. Thus, the DVS 10 can detect a change in brightness without blown-out highlights occurring in a bright state of backlight, and can also appropriately detect the change in brightness in a dark state, conversely.

[Example of Event Information Acquired from DVS]

(When Own Vehicle is Traveling)

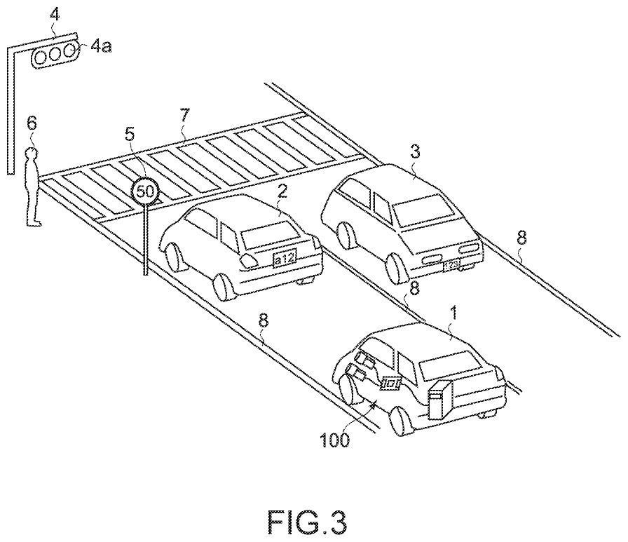

Here, what kind of event information is acquired from the DVS 10 when the DVS 10 is included in a vehicle is described. FIG. 3 illustrates a state in which a vehicle that includes the DVS 10 is traveling on an ordinary road.

In the example illustrated in FIG. 3, a vehicle 1 (hereinafter referred to as an own vehicle 1) that includes the DVS 10 (the automated-driving control system 100) is traveling in a left lane, and another vehicle 2 (hereinafter referred to as a vehicle ahead 2) is traveling ahead of the own vehicle 1 in the same lane. Further, in the example illustrated in FIG. 3, another vehicle 3 (hereinafter referred to as an oncoming vehicle 3) is traveling in an opposite lane toward the own vehicle 1 from a direction of the forward movement of the own vehicle 1. Furthermore, in FIG. 3, there are, for example, a traffic light 4, a traffic sign 5, a pedestrian 6, a crosswalk 7, and a partition line 8 used to mark the boundary between lanes.

Since the DVS 10 can detect a change in brightness, an edge of a target object in which there is a difference in speed between the own vehicle 1 (the DVS 10) and the target object, can be detected in essence as event information. In the example illustrated in FIG. 3, there is a difference in speed between the own vehicle 1 and each of the vehicle ahead 2, the oncoming vehicle 3, the traffic light 4, the traffic sign 5, the pedestrian 6, and the crosswalk 7. Thus, edges of these target objects are detected by the DVS 10 as event information.

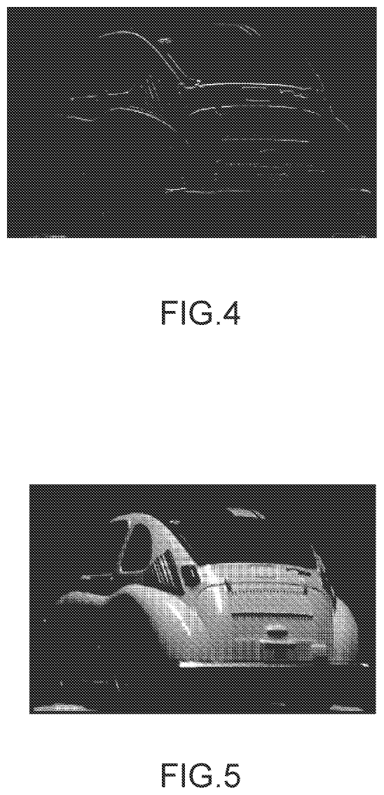

FIG. 4 illustrates information regarding an edge of the vehicle ahead 2 that is acquired by the DVS 10. FIG. 5 illustrates an example of an image of the vehicle ahead 2 that is acquired by an image sensor.

In the example illustrated in FIG. 3, an edge of the vehicle ahead 2 illustrated in FIG. 4, and edges of, for example, the oncoming vehicle 3, the traffic light 4, the traffic sign 5, the pedestrian 6, and the crosswalk 7 are detected by the DVS 10 as event information.

Further, the DVS 10 can detect a target object of which the brightness is changed due to, for example, an emission of light, regardless of whether there is a difference in speed between the own vehicle 1 (the DVS 10) and the target object. For example, a light portion 4a that is turned on in the traffic light 4 keeps on blinking on and off with a period with which the blinking is not recognized by a human. Thus, the light portion 4a turned on in the traffic light 4 can be detected by the DVS 10 as a portion in which there is a change in brightness, regardless of whether there is a difference in speed between the own vehicle 1 and the light portion 4a.

On the other hand, there is a target object that is exceptionally not captured as a portion in which there is a change in brightness even if there is a difference in speed between the own vehicle 1 (the DVS 10) and the target object. There is a possibility that such a target object will not be detected by the DVS 10.

For example, when there is the straight partition line 8, as illustrated in FIG. 3, and when the own vehicle 1 is traveling parallel to the partition line 8, there is no change in the appearance of the partition line 8, and thus there is no change in the brightness in the partition line 8, as viewed from the own vehicle 1. Thus, there is a possibility that, in such a case, the partition line 8 will not be detected by the DVS 10 as a portion in which there is a change in brightness. Note that, when the partition line 8 is not parallel to a direction in which the own vehicle 1 is traveling, the partition line 8 can be detected by the DVS 10 as usual.

For example, there is a possibility that, for example, the partition line 8 will not be detected as a portion in which there is a change in brightness even if there is a difference in speed between the own vehicle 1 and the partition line 8. Thus, in the first embodiment, complement is performed on the basis of complementary information acquired by a complementary sensor described later with respect to such a target object that is not detected by the DVS 10.

(When Own Vehicle is Stopped)

Next, it is assumed that, for example, the own vehicle 1 is stopped to wait for a traffic light to change in FIG. 3. In this case, a target object in which there is a difference in speed between the own vehicle 1 and the target object, that is, edges of the oncoming vehicle 3 and the pedestrian 6 (when he/she is moving) are detected by the DVS 10 as event information. Further, the light portion 4a turned on in the traffic light 4 is detected by the DVS 10 as event information regardless of whether there is a difference in speed between the own vehicle 1 and the light portion 4a.

On the other hand, with respect to a target object in which there is no difference in speed between the own vehicle 1 (the DVS 10) and the target object due to the own vehicle 1 being stopped, there is a possibility that an edge of the target object will not be detected. For example, when, similarly to the own vehicle 1, the vehicle ahead 2 is stopped to wait for a traffic light to change, an edge of the vehicle ahead 2 is not detected. Further, edges of the traffic light 4 and the traffic sign 5 are also not detected.

Note that, in the first embodiment, complement is performed on the basis of complementary information acquired by the complementary sensor described later with respect to a target object that is not detected by the DVS 10.

[Automated-Driving Control Apparatus 30]

Referring again to FIG. 2, the automated-driving control apparatus 30 includes a controller 31. The controller 31 performs various computations on the basis of various programs stored in a storage (not illustrated), and performs an overall control on the automated-driving control apparatus 30. The storage stores therein various programs and various pieces of data that are necessary for processing performed by the controller 31 of the automated-driving control apparatus 30.

The controller 31 of the automated-driving control apparatus 30 is implemented by hardware or a combination of hardware and software. The hardware is configured as a portion of, or all of the controller 31, and examples of the hardware include a central processing unit (CPU), a graphics processing unit (GPU), a digital signal processor (DSP), a field programmable gate array (FPGA), an application specific integrated circuit (ASIC), and a combination of two or more of them. Note that the same applies to a controller 41 of the sensor apparatus 40 that will be described later.

For example, the controller 31 of the automated-driving control apparatus 30 performs processing of recognizing a target object using the DVS 10, performs processing of specifying a region-of-interest (ROI) location that corresponds to the target object recognized using the DVS 10, and makes a request that a ROI image that corresponds to the ROI location be acquired. Further, for example, the controller 31 of the automated-driving control apparatus 30 performs processing of recognizing a target object on the basis of a ROI image, processing of designing a driving plan on the basis of the target object recognized on the basis of the ROI image, and processing of generating operation control data on the basis of the designed driving plan.

Note that the processes performed by the controller 31 of the automated-driving control apparatus 30 will be described in detail later when the operation is described.

[Sensor Apparatus 40]

The sensor apparatus 40 includes the controller 41 and a sensor unit 42 (a sensor section). The sensor unit 42 can acquire information regarding a target object that is necessary to design a driving plan. The sensor unit 42 includes a sensor other than the DVS 10, and, specifically, the sensor unit 42 includes an image sensor 43, lidar 44, a millimeter-wave radar 45, and an ultrasonic sensor 46.

The controller 41 of the sensor apparatus 40 performs various computations on the basis of various programs stored in a storage (not illustrated), and performs an overall control on the sensor apparatus 40. The storage stores therein various programs and various pieces of data that are necessary for processing performed by the controller 41 of the sensor apparatus 40.

For example, the controller 41 of the sensor apparatus 40 performs ROI cutout processing of cutting a portion corresponding to a ROI location out of an overall image that is acquired by the image sensor 43, and modification processing of modifying a ROI cutout location.

Note that the processes performed by the controller 41 of the sensor apparatus 40 will be described in detail later when the operation is described.

The image sensor 43 includes an imaging device such as a charge coupled device (CCD) sensor and a complemented metal-oxide semiconductor (CMOS) sensor, and an optical system such as an image-formation lens. The image sensor 43 is a frame-based sensor that outputs an overall image at a specified frame rate.

The lidar 44 includes a light-emitting section that emits laser light in the form of a pulse, and a light-receiving section that can receive a wave reflected off a target object. The lidar 44 measures the time from the laser light being emitted by the light-emitting section to the laser light being reflected off the target object to be received by the light-receiving section. Accordingly, the lidar 44 can detect, for example, a distance to the target object and an orientation of the target object. The lidar 44 can record a direction and a distance of a reflection of pulsed laser light in the form of a point in a group of three-dimensional points, and can acquire an environment around the own vehicle 1 as information in the form of a group of three-dimensional points.

The millimeter-wave radar 45 includes an emission antenna that can emit a millimeter wave (an electromagnetic wave) of which a wavelength is of the order of millimeters, and a reception antenna that can receive a wave reflected off a target object. The millimeter-wave radar 45 can detect, for example, a distance to a target object and an orientation of the target object on the basis of a difference between a millimeter wave emitted by the emission antenna and a millimeter wave reflected off the target object to be received by the reception antenna.

The ultrasonic sensor 46 includes an emitter that can emit an ultrasonic wave, and a receiver that can receive a wave reflected off a target object. The ultrasonic sensor 46 measures the time from the ultrasonic wave being emitted by the emitter to the ultrasonic wave being reflected off the target object to be received by the receiver. Accordingly, the ultrasonic sensor 46 can detect, for example, a distance to the target object and an orientation of the target object.

The five sensors that are the four sensors 43, 44, 45, and 46 in the sensor unit 42 and the DVS 10 are synchronized with each other on the order of microseconds using, for example, a protocol such as the Precision Time Protocol (PTP).

An overall image captured by the image sensor 43 is output to the controller 41 of the sensor apparatus 40. Further, the overall image captured by the image sensor 43 is transmitted to the automated-driving control apparatus as sensor information. Likewise, pieces of information that are acquired by the lidar 44, the millimeter-wave radar 45, and the ultrasonic sensor 46 are output to the automated-driving control apparatus 30 as pieces of sensor information.

The sensor information acquired by each of the four sensors 43, 44, 45, and 46 is information used to recognize a target object that is not recognized using event information acquired by the DVS 10. In this sense, the sensor information acquired by each sensor is complementary information.

In the description herein, a sensor that acquires ROI-cutout-target information is referred to as a ROI-target sensor. Further, a sensor that acquires information (complementary information) used to recognize a target object that is not recognized using event information acquired by the DVS 10 is referred to as a complementary sensor.

In the first embodiment, the image sensor 43 is a ROI-target sensor since the image sensor 43 acquires image information that corresponds to a ROI-cutout target. Further, the image sensor 43 is also a complementary sensor since the image sensor 43 acquires the image information as complementary information. In other words, the image sensor 43 serves as a ROI-target sensor and a complementary sensor.

Further, in the first embodiment, the lidar 44, the millimeter-wave radar 45, and the ultrasonic sensor 46 are complementary sensors since the lidar 44, the millimeter-wave radar 45, and the ultrasonic sensor 46 each acquire sensor information as complementary information.

Note that the ROI-target sensor is not limited to the image sensor 43. For example, instead of the image sensor 43, the lidar 44, the millimeter-wave radar 45, or the ultrasonic sensor 46 may be used as the ROI-target sensor. In this case, the ROI cutout processing may be performed on information acquired by the lidar 44, the millimeter-wave radar 45, or the ultrasonic sensor 46 to acquire ROI information.

At least two of the four sensors that are the image sensor 43, the lidar 44, the millimeter-wave radar 45, and the ultrasonic sensor 46 may be used as ROI-target sensors.

In the first embodiment, the four sensors that are the image sensor 43, the lidar 44, the millimeter-wave radar 45, and the ultrasonic sensor 46 are used as complementary sensors, and, typically, it is sufficient if at least one of the four sensors is used as a complementary sensor. Note that at least two of the four sensors may be used as ROI-target sensors and complementary sensors.

[Automated Driving Performing Apparatus 20]

On the basis of operation control data from the automated-driving control apparatus 30, the automated driving performing apparatus 20 performs automated driving by controlling, for example, an accelerator mechanism, a brake mechanism, and a steering mechanism.

<Description of Operation>

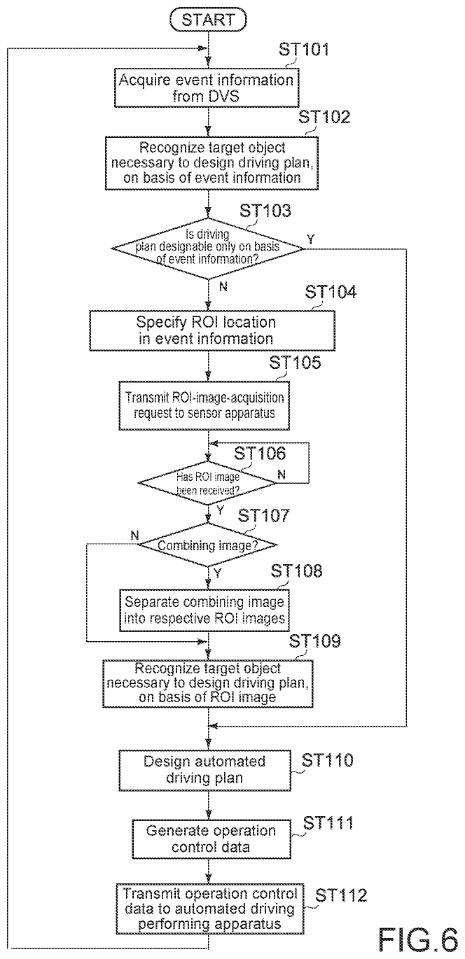

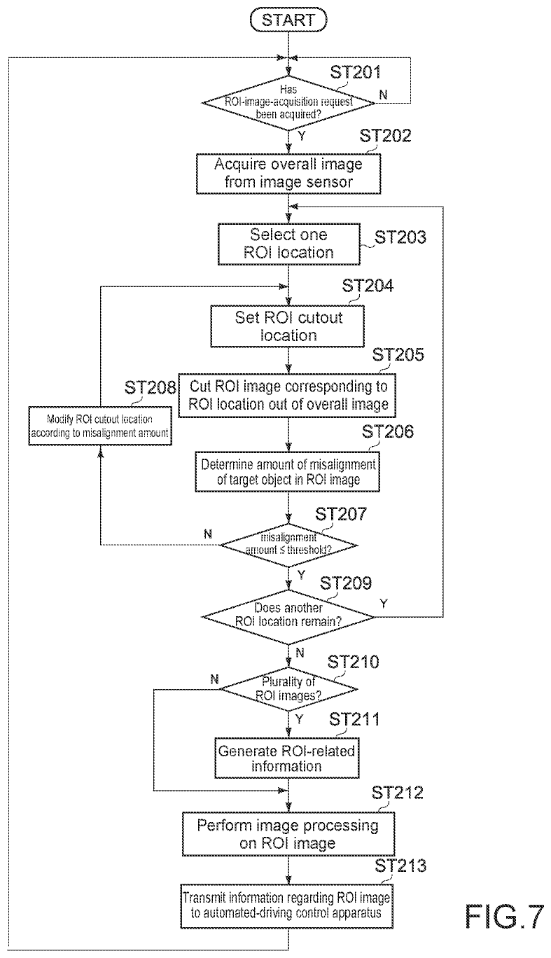

Next, processing performed by the controller 31 of the automated-driving control apparatus 30, and processing performed by the controller 41 of the sensor apparatus 40 are described. FIG. 6 is a flowchart illustrating the processing performed by the controller 31 of the automated-driving control apparatus 30. FIG. 7 is a flowchart illustrating the processing performed by the controller 41 of the sensor apparatus 40.

Referring to FIG. 6, first, the controller 31 of the automated-driving control apparatus 30 acquires event information (time-series data that includes coordinate information related to a change in brightness: for example, the information regarding an edge illustrated in FIG. 4) from the DVS 10 (Step 101). Next, the controller 31 of the automated-driving control apparatus 30 recognizes a target object that is necessary to design a driving plan on the basis of the event information (Step 102). Examples of the target object necessary to design a driving plan include the vehicle ahead 2, the oncoming vehicle 3, the traffic light 4 (including the light portion 4a), the traffic sign 5, the pedestrian 6, the crosswalk 7, and the partition line 8.

Here, for example, the vehicle ahead 2, the oncoming vehicle 3, the traffic light 4, the pedestrian 6, the crosswalk 7, and the partition line 8 can be recognized in essence by the controller 31 of the automated-driving control apparatus 30 on the basis of the event information from the DVS 10 when there is a difference in speed between the own vehicle 1 (the DVS 10) and each of the vehicle ahead 2, the oncoming vehicle 3, the traffic light 4, the pedestrian 6, the crosswalk 7, and the partition line 8. On the other hand, there is a possibility that, for example, the partition line 8 will exceptionally be not recognized by the controller 31 of the automated-driving control apparatus 30 on the basis of the event information from the DVS 10, even if there is a difference in speed between the own vehicle 1 (the DVS 10) and the partition line 8. Note that the light portion 4a turned on in the traffic light 4 can be recognized by the controller 31 of the automated-driving control apparatus 30 on the basis of the event information from the DVS 10 regardless of whether there is a difference in speed between the own vehicle 1 (the DVS 10) and the light portion 4a.

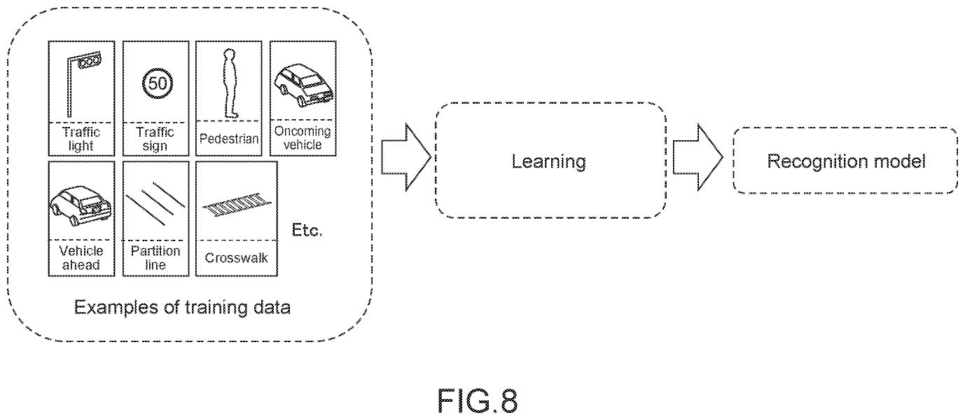

In Step 102, the controller 31 of the automated-driving control apparatus 30 recognizes a target object by comparing the target object with a first recognition model stored in advance. FIG. 8 illustrates a state in which a recognition model is generated.

As illustrated in FIG. 8, first, training data for a target object that is necessary to design a driving plan is provided. Training data based on event information obtained when an image of the target object is captured using the DVS 10 is used as the training data for the target object. For example, data obtained by creating a library of information regarding movement performed on a temporal axis is used as the training data, the information regarding the movement being included in time-series data that includes coordinate information (such as an edge) related to a change in the brightness in the target object. Using the training data, learning is performed by machine learning that uses, for example, a neural network, and the first recognition model is generated.

After recognizing the target object necessary to design a driving plan on the basis of the event information from the DVS 10, the controller 31 of the automated-driving control apparatus 30 determines whether the driving plan is designable, without acquiring a ROI image, only using information regarding the target object recognized on the basis of the event information from the DVS 10 (Step 103).

When, for example, the vehicle ahead 2 is likely to collide with the own vehicle 1 due to sudden braking in FIG. 2, the controller 31 of the automated-driving control apparatus 30 understands from the event information that the vehicle ahead 2 is likely to collide with the own vehicle 1 (since an edge that indicates the vehicle ahead 2 is approaching the own vehicle 1).

Further, when, for example, the pedestrian 6 is likely to run in front of the own vehicle 1 in FIG. 2, the controller 31 of the automated-driving control apparatus 30 can understand from the event information that the pedestrian 6 is likely to run in front of the own vehicle 1 (since an edge that indicates the pedestrian 6 is about to cross in front of the own vehicle 1).

In, for example, such an emergency, the controller 31 of the automated-driving control apparatus 30 determines that the driving plan is designable, without acquiring a ROI image, only using information regarding the target object recognized on the basis of the event information from the DVS 10 (YES in Step 103)

In this case, the controller 31 of the automated-driving control apparatus 30 does not transmit a ROI-image-acquisition request to the sensor apparatus 40, and designs an automated driving plan only using information regarding the target object recognized by the DVS 10 (Step 110). Then, the controller 31 of the automated-driving control apparatus 30 generates operation control data in conformity with the designed automated driving plan, on the basis of the automated driving plan (Step 111), and transmits the generated operation control data to the automated driving performing apparatus 20 (Step 112).

Here, the event information is output by the DVS 10 at a high speed, as described above, and an amount of data of the event information is small. Thus, for example, it takes a shorter time to recognize a target object, compared to when an overall image from the image sensor 43 is globally analyzed to recognize the target object. Thus, in, for example, the emergency described above, an emergency event can be avoided by quickly designing a driving plan only using information regarding a target object recognized on the basis of event information.

When it has been determined, in Step 103, that the automated driving plan is not designable only using information regarding a target object recognized on the basis of the event information from the DVS 10 (NO in Step 103), the controller 31 of the automated-driving control apparatus 30 moves on to Step 104, which is subsequent to Step 103. Note that it is typically determined that an automated driving plan is not designable except for the emergency described above.

In Step 104, the controller 31 of the automated-driving control apparatus 30 specifies, as a ROI location, a certain region that is from among coordinate locations included in the event information from the DVS 10 and corresponds to the target object. The number of ROIs specified as corresponding target objects may be one, or two or more. For example, when there is one target object recognized on the basis of event information from the DVS 10, there is also one ROI location correspondingly to the number of target objects. When there are two or more target objects recognized on the basis of the event information from the DVS 10, there are also two or more ROI locations correspondingly to the number of target objects.

Next, the controller 31 of the automated-driving control apparatus 30 transmits, to the sensor apparatus 40, a ROI-image-acquisition request that includes information regarding the ROI location (Step 105).

Referring to FIG. 7, the controller 41 of the sensor apparatus 40 determines whether a ROI-image-acquisition request has been received from the automated-driving control apparatus 30 (Step 201). When the controller 41 of the sensor apparatus 40 has determined that the ROI-image-acquisition request has not been received (NO in Step 201), the controller 41 of the sensor apparatus 40 determines again whether the ROI-image-acquisition request has been received from the automated-driving control apparatus 30. In other words, the controller 41 of the sensor apparatus 40 waits for the ROI-image-acquisition request to be received.

When the controller 41 of the sensor apparatus 40 has determined that the ROI-image-acquisition request has been received from the automated-driving control apparatus 30 (YES in Step 201), the controller 41 of the sensor apparatus 40 acquires an overall image from the image sensor 43 (Step 202). Next, the controller 41 of the sensor apparatus 40 selects one of ROI locations included in the ROI-image-acquisition request (Step 203).

Next, the controller 41 of the sensor apparatus 40 sets a cutout location for a ROI image in the overall image (Step 204), and cuts a ROI image corresponding to the ROI location out of the overall image (Step 205).

Next, the controller 41 of the sensor apparatus 40 analyzes the ROI image to determine an amount of misalignment of the target object in the ROI image (Step 206). In other words, the controller 41 of the sensor apparatus 40 determines whether the target object is within the ROI image properly.

Next, the controller 41 of the sensor apparatus 40 determines whether the misalignment amount is less than or equal to a specified threshold (Step 207). When the controller 41 of the sensor apparatus 40 has determined that the misalignment amount is greater than the specified threshold (NO in Step 207), the controller of the sensor apparatus 40 modifies the ROI cutout location according to the misalignment amount (Step 208). Then, the controller 41 of the sensor apparatus 40 cuts a ROI image out of the overall image again correspondingly to the modified ROI cutout location.

When the controller 41 of the sensor apparatus 40 has determined, in Step 207, that the misalignment amount is less than or equal to the specified threshold (YES in Step 207), the controller 41 of the sensor apparatus 40 determines whether another ROI location for which a ROI image has not yet been cut out remains (Step 209). When the controller 41 of the sensor apparatus 40 has determined that the other ROI location remains (YES in Step 209), the controller 41 of the sensor apparatus 40 returns to Step 203, selects one of the remaining ROI locations, and cuts a ROI image corresponding to the selected ROI location out of the overall image.

Note that, as can be seen from the description herein, the ROI image (ROI information) is a partial image that is cut as a portion corresponding to a ROI location out of an overall image acquired by the image sensor 43.

For example, it is assumed that, when, for example, the vehicle ahead 2, the oncoming vehicle 3, the traffic light 4 (including the light portion 4a), the traffic sign 5, the pedestrian 6, the crosswalk 7, and the partition line 8 are recognized as target objects on the basis of event information from the DVS 10, locations that respectively correspond to the target objects are determined to be ROI locations. In this case, portions that respectively correspond to, for example, the vehicle ahead 2, the oncoming vehicle 3, the traffic light 4 (including the light portion 4a), the traffic sign 5, the pedestrian 6, the crosswalk 7, and the partition lines 8 are cut out of an overall image acquired by the image sensor 43, and respective ROI images are generated. Note that one ROI image corresponds to one target object (one ROI location).

Note that the controller 41 of the sensor apparatus 40 may determine not only an amount of misalignment of a target object in a ROI image, but also an amount of exposure performed when an image from which the ROI image is generated is captured by the image sensor 43. In this case, the controller 41 of the sensor apparatus 40 analyzes the ROI image to determine whether the amount of the exposure performed when the image from which the ROI image is generated is captured is within an appropriate range. When the controller 41 of the sensor apparatus 40 has determined that the exposure amount is not within the appropriate range, the controller 41 of the sensor apparatus 40 generates information regarding an exposure amount that is used to modify an exposure amount, and adjusts the amount of the exposure performed with respect to the image sensor 43.

When the controller 41 of the sensor apparatus 40 has determined, in Step 209, that ROI images that respectively correspond to all of the ROI locations are cut out (NO in Step 209), then the controller 41 of the sensor apparatus 40 determines whether there is a plurality of generated ROI images (Step 210). When the controller 41 of the sensor apparatus 40 has determined that there is a plurality of ROI images (NO in Step 210), the controller 41 of the sensor apparatus 40 generates ROI-related information (Step 211), and moves on to Step 212, which is subsequent to Step 211.

The ROI-related information is described. When there is a plurality of ROI images, ROI images of the plurality of ROI images are combined to be transmitted to the automated-driving control apparatus 30 in the form of a single combining image. The ROI-related information is information used to identify which of the portions of the single combining image corresponds to which of the ROI images.

When the controller 41 of the sensor apparatus 40 has determined, in Step 210, that there is a single ROI image (NO in Step 210), the controller 41 of the sensor apparatus 40 does not generate ROI-related data, and moves on to Step 212.

In Step 212, the controller 41 of the sensor apparatus 40 performs image processing on the ROI image. The image processing is performed to enable the controller 31 of the automated-driving control apparatus 30 to accurately recognize the target object in Step 109 described later (refer to FIG. 6).

Examples of the image processing include a digital-gain process, white balancing, a look-up-table (LUT) process, a color-matrix conversion, defect correction, shooting correction, denoising, gamma correction, and demosaicing (for example, returning to the RGB arrangement from the Bayer arrangement output by an imaging device).

After performing the image processing on the ROI image, the controller 41 of the sensor apparatus 40 transmits ROI-image information to the automated-driving control apparatus 30 (Step 213). Note that, when there is a single ROI image, the controller 41 of the sensor apparatus 40 transmits the single ROI image to the automated-driving control apparatus 30 as ROI-image information. On the other hand, when there is a plurality of ROI images, the controller 41 of the sensor apparatus 40 combines ROI images of the plurality of ROI images to obtain a single combining image, and transmits the single combining image to the automated-driving control apparatus 30 as ROI-image information. In this case, ROI-related information is included in the ROI-image information.

When the controller 41 of the sensor apparatus 40 transmits the ROI-image information to the automated-driving control apparatus 30, the controller 41 of the sensor apparatus 40 returns to Step 201, and determines whether a ROI-image acquisition request has been received from the automated-driving control apparatus 30.

Referring again to FIG. 6, after transmitting a ROI-image-acquisition request to the sensor apparatus 40, the controller 31 of the automated-driving control apparatus 30 determines whether ROI-image information has been received from the sensor apparatus 40 (Step 106).

When the controller 31 of the automated-driving control apparatus 30 has determined that the ROI-image information has not been received (NO in Step 106), the controller 31 of the automated-driving control apparatus 30 determines again whether the ROI-image information has been received. In other words, the controller 31 of the automated-driving control apparatus 30 waits for the ROI-image information to be received after making a ROI-image-acquisition request.

When the controller 31 of the automated-driving control apparatus 30 has determined that the ROI-image information has been received (YES in Step 106), the controller 31 of the automated-driving control apparatus 30 determines whether the received ROI-image information is a combining image obtained by combining ROI images of a plurality of ROI images (Step 107).

When the controller 31 of the automated-driving control apparatus 30 has determined that the received ROI-image information is the combining image obtained by combining the ROI images of the plurality of ROI images (YES in Step 107), the controller 31 of the automated-driving control apparatus 30 separates the combining image into the respective ROI images on the basis of ROI-related information (Step 108), and moves on to Step 109, which is subsequent to Step 108. On the other hand, when the controller 31 of the automated-driving control apparatus 30 has determined that the received ROI-image information is a single ROI image (NO in Step 107), the controller 31 of the automated-driving control apparatus 30 does not perform processing of the separation, and moves on to Step 109.

In Step 109, the controller 31 of the automated-driving control apparatus 30 recognizes, on the basis of the ROI image, a target object that is necessary to design a driving planning. In this case, the processing of recognizing a target object is performed by comparing the target object with a second recognition model stored in advance.

Referring to FIG. 8, the second recognition model is also generated in essence on the basis of an idea that is similar to the ideal in the case of the first recognition model. However, data based on event information obtained when an image of a target object is captured using the DVS 10 is used as training data in the case of the first recognition model, whereas data based on image information obtained when an image of a target object is captured by the image sensor 43 is used as training data in the case of the second recognition model, which is different from the case of the first recognition model. Using the above-described training data based on image information, learning is performed by machine learning that uses, for example, a neural network, and the second recognition model is generated.

When the controller 31 of the automated-driving control apparatus 30 performs processing of recognizing a target object on the basis of an ROI image, this makes it possible to recognize a target object in more detail, compared to when the target object is recognized on the basis of event information. For example, the controller can recognize, for example, a number in a license plate and a color of a brake lamp of each of the vehicle ahead 2 and the oncoming vehicle 3, a color of the light portion 4a in the traffic light 4, a word typed on the traffic sign 5, an orientation of the face of the pedestrian 6, and a color of the partition line 8.

After recognizing the target object on the basis of the ROI image, the controller 31 of the automated-driving control apparatus 30 designs an automated driving plan on the basis of information regarding a target object recognized on the basis of the ROI image (and information regarding a target object recognized on the basis of event information) (Step 110). Then, the controller 31 of the automated-driving control apparatus 30 generates operation control data in conformity with the designed automated driving plan, on the basis of the automated driving plan (Step 111), and transmits the generated operation control data to the automated driving performing apparatus 20 (Step 112).

In other words, the present embodiment adopts an approach in which a ROI image is acquired by specifying, on the basis of event information from the DVS 10, a ROI location that corresponds to a target object that is necessary to design a driving plan, and the target object is recognized on the basis of the acquired ROI image.

As described above, instead of an overall image, a ROI image is acquired in the present embodiment in order to recognize a target object. Thus, the present embodiment has the advantage that an amount of data is smaller and thus it takes a shorter time to acquire an image, compared to when an overall image is acquired each time.

Further, a target object is recognized using a ROI image of which a data amount is reduced by ROI processing. Thus, the present embodiment has the advantage that it takes a shorter time to recognize a target object, compared to when an overall image is globally analyzed to recognize the target object. Furthermore, the present embodiment also makes it possible to recognize a target object accurately since the target object is recognized on the basis of a ROI image. In other words, the present embodiment makes it possible to recognize a target object quickly and accurately.

Here, there is a possibility that a target object in which there is no difference in speed between the own vehicle 1 (the DVS 10) and the target object will not be recognized using event information from the DVS 10. Thus, there is a possibility that such a target object will not be recognized using a ROI image. Thus, in the present embodiment, the controller 31 of the automated-driving control apparatus 30 recognizes a target object that is necessary to design a driving plan, not only on the basis of a ROI image, but also on the basis of complementary information from the sensor unit 42 in the sensor apparatus 40.

For example, the partition line 8 extending in parallel with the traveling own vehicle 1, and a target object that is no longer captured as a portion in which there is a change in brightness, due to the own vehicle 1 being stopped, are recognized by the controller 31 of the automated-driving control apparatus 30 on the basis of complementary information from the sensor unit 42.

With a specified period, the controller 31 of the automated-driving control apparatus 30 repeatedly performs a series of processes that includes specifying a ROI location in event information, acquiring a ROI image, and recognizing, on the basis of the ROI image, a target object that is necessary to design a driving plan, as described above (Steps 101 to 109 of FIG. 6). Note that this series of processes is hereinafter referred to as a series of recognition processes based on a ROI image.

Further, in parallel with performing the series of recognition processes based on a ROI image, the controller 31 of the automated-driving control apparatus 30 repeatedly performs, with a specified period, a series of processes that includes acquiring complementary information from the sensor apparatus 40 and recognizing, on the basis of the complementary information, a target object that is necessary to design a driving plan. Note that this series of processes is hereinafter referred to as a series of recognition processes based on complementary information.

In the series of recognition processes based on complementary information, the controller 31 of the automated-driving control apparatus 30 recognizes a target object by globally analyzing respective pieces of complementary information from the four sensors in the sensor unit 42. Consequently, the controller 31 of the automated-driving control apparatus 30 can also appropriately recognize a target object that is not recognized using event information or a ROI image.

In the series of recognition processes based on complementary information, there is a need to globally analyze respective pieces of complementary information from the sensors. Thus, the series of recognition processes based on complementary information takes a longer time, compared to when a ROI image is analyzed. Thus, the series of recognition processes based on complementary information is performed with a period longer than a period with which the series of recognition processes based on a ROI image is performed. The series of recognition processes based on complementary information is performed with a period about several times longer than a period with which the series of recognition processes based on a ROI image is performed.

For example, the series of recognition processes based on complementary information is performed once every time the series of recognition processes based on a ROI image is repeatedly performed several times. In other words, when a target object is recognized on the basis of a ROI image by the series of recognition processes based on a ROI image (refer to Step 109), a target object is recognized on the basis of complementary information once every time the series of recognition processes based on a ROI image is repeatedly performed several times. At this point, an automated driving plan is designed using information regarding a target object recognized on the basis of a ROI image, and information regarding a target object recognized on the basis of complementary information (and information regarding a target object recognized on the basis of event information) (refer to Step 110).

Here, when the own vehicle 1 is stopped, it is more often the case that there is no difference in speed between the own vehicle 1 and a target object, compared to when the own vehicle 1 is traveling. Thus, when the own vehicle 1 is stopped, it is more difficult to recognize a target object in event information, compared to when the own vehicle 1 is traveling.

Thus, the controller 31 of the automated-driving control apparatus 30 may acquire information regarding a movement of the own vehicle 1, and may change a period with which the series of recognition processes based on complementary information is performed, on the basis of the information regarding the movement of the own vehicle 1. The information regarding a movement of the own vehicle 1 can be acquired from information regarding a speedometer and information regarding, for example, the Global Positioning System (GPS).

In this case, for example, the period with which the series of recognition processes based on complementary information is performed may be made shorter as the movement of the own vehicle 1 becomes slower. This makes it possible to, for example, appropriately recognize, using complementary information, a target object that is not captured by the DVS 10 as a portion in which there is a change in brightness, due to the movement of the own vehicle 1 becoming slower.

Note that, conversely, the period with which the series of recognition processes based on complementary information is performed may be made shorter as the movement of the own vehicle 1 becomes faster. This is based on the idea that there will be a need to more accurately recognize a target object if the own vehicle 1 moves faster.

### Specific Block Configuration: First Example

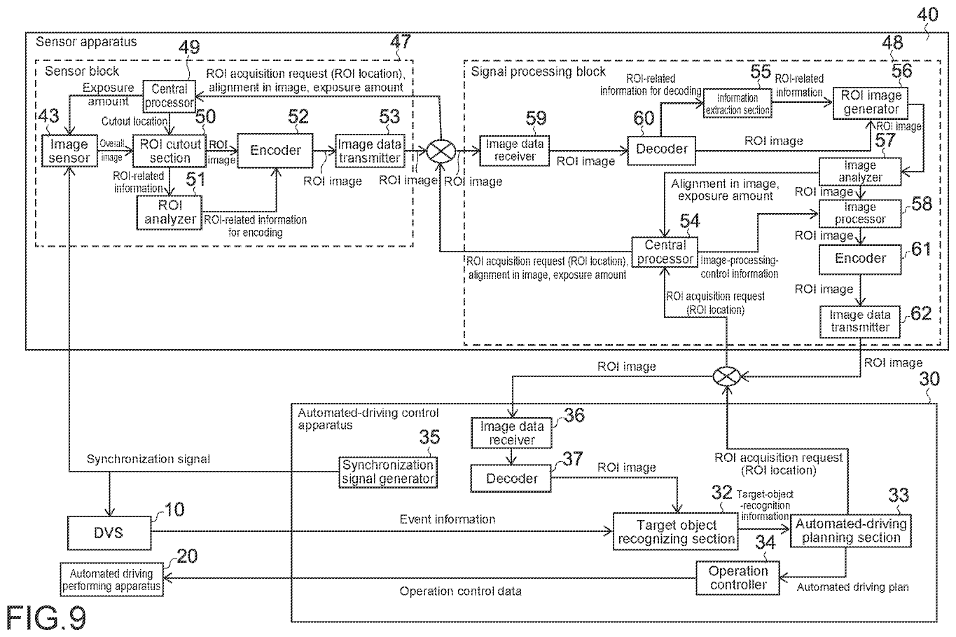

Next, a specific block configuration in the automated-driving control system 100 is described. FIG. 9 illustrates an example of the specific block configuration in the automated-driving control system 100.

Note that, in FIG. 9, the lidar 44, the millimeter-wave radar 45, and the ultrasonic sensor 46 from among the four sensors in the sensor unit 42 in FIG. 2 are omitted, and only the image sensor 43 is illustrated. Further, in FIG. 9, a flow of sensor information (complementary information) in the sensor unit 42 in FIG. 2 is also omitted, and only a flow of a ROI image is illustrated.

As illustrated in FIG. 9, the automated-driving control apparatus 30 includes a target object recognizing section 32, an automated-driving planning section 33, an operation controller 34, a synchronization signal generator 35, an image data receiver 36, and a decoder 37.

Further, the sensor apparatus 40 includes a sensor block 47 and a signal processing block 48. The sensor block 47 includes the image sensor 43, a central processor 49, a ROI cutout section 50, a ROI analyzer 51, an encoder 52, and an image data transmitter 53. The signal processing block 48 includes a central processor 54, an information extraction section 55, a ROI image generator 56, an image analyzer 57, an image processor 58, an image data receiver 59, a decoder 60, an encoder 61, and an image data transmitter 62.

Note that the controller 31 of the automated-driving control apparatus 30 illustrated in FIG. 2 corresponds to, for example, the target object recognizing section 32, the automated-driving planning section 33, the operation controller 34, and the synchronization signal generator 35 illustrated in FIG. 9. Further, the controller 41 of the sensor apparatus 40 illustrated in FIG. 2 corresponds to, for example, the central processor 49, the ROI cutout section 50, and the ROI analyzer 51 in the sensor block 47 illustrated in FIG. 9; and the central processor 54, the information extraction section 55, the ROI image generator 56, the image analyzer 57, and the image processor 58 in the signal processing block 48 illustrated in FIG. 9.

“Automated-Driving Control Apparatus”

First, the automated-driving control apparatus 30 is described. The synchronization signal generator 35 is configured to generate a synchronization signal according to a protocol such as the Precision Time Protocol (PTP), and to output the synchronization signal to the DVS 10, the image sensor 43, the lidar 44, the millimeter-wave radar 45, and the ultrasonic sensor 46. Accordingly, the five sensors including the DVS 10, the image sensor 43, the lidar 44, the millimeter-wave radar 45, and the ultrasonic sensor 46 are synchronized with each other, for example, on the order of microseconds.

The target object recognizing section 32 is configured to acquire event information from the DVS 10, and to recognize, on the basis of the event information, a target object that is necessary to design a driving plan (refer to Steps 101 and 102). The target object recognizing section 32 is configured to output, to the automated-driving planning section 33, information regarding the target object recognized on the basis of the event information.

Further, the target object recognizing section 32 is configured to determine whether ROI-image information is a combining image after the ROI-image information is received from the sensor apparatus 40, the combining image being obtained by combining ROI images of a plurality of ROI images (refer to Step 107). The target object recognizing section 32 is configured to separate, when the ROI-image information is the combining image obtained by combining the ROI images of the plurality of ROI images, the combining image into the respective ROI images on the basis of ROI-related information (refer to Step 108).

Further, the target object recognizing section 32 is configured to recognize a target object that is necessary to design an automated driving plan, on the basis of the ROI image (refer to Step 109). Furthermore, the target object recognizing section 32 is configured to output, to the automated-driving planning section 33, information regarding a target object recognized on the basis of the ROI image.

Further, the target object recognizing section 32 is configured to recognize a target object that is necessary to design an automated driving plan, on the basis of complementary information acquired by the sensor apparatus 40. The target object recognizing section 32 outputs, to the automated-driving planning section 33, information regarding a target object recognized on the basis of the complementary information.

The automated-driving planning section 33 is configured to determine, after acquiring information regarding a target object recognized on the basis of event information, whether a driving plan is designable, without acquiring a ROI image, only using the information regarding the target object recognized on the basis of the event information, the information regarding the target object recognized on the basis of the event information being acquired from the target object recognizing section 32 (refer to Step 103).

The automated-driving planning section 33 is configured to design, when a driving plan is designable only using the information regarding the target object recognized on the basis of the event information, an automated driving plan only using this information (refer to the processes from YES in Step 103 to Step 110).

Further, the automated-driving planning section 33 is configured to specify a certain region as a ROI location when a driving plan is not designable only using this information, the certain region being from among coordinate locations included in the event information acquired from the DVS 10, and corresponding to the target object (refer to Step 104).

Further, the automated-driving planning section 33 is configured to transmit a ROI-image-acquisition request to the sensor apparatus 40 after specifying the ROI location, the ROI-image-acquisition request including information regarding the ROI location (refer to Step 105). Furthermore, the automated-driving planning section 33 is configured to transmit a complementary-information-acquisition request to the sensor apparatus 40.

Further, the automated-driving planning section 33 is configured to design, after acquiring information regarding a target object recognized on the basis of a ROI image, an automated driving plan on the basis of the information regarding the target object recognized on the basis of the ROI image (and information regarding a target object recognized on the basis of event information), the information regarding the target object recognized on the basis of the ROI image being acquired from the target object recognizing section 32 (refer to Steps 109 and Step 110).

Further, the automated-driving planning section 33 is configured to design, after acquiring information regarding a target object recognized on the basis of complementary information, an automated driving plan on the basis of information regarding a target object recognized on the basis of a ROI image, and the information regarding the target object recognized on the basis of the complementary information (and information regarding a target object recognized on the basis of event information), the information regarding the target object recognized on the basis of the complementary information being acquired from the target object recognizing section 32.

Further, the automated-driving planning section 33 is configured to output the designed automated driving plan to the operation controller 34.

The operation controller 34 is configured to generate, on the basis of the automated driving plan acquired from the automated-driving planning section 33, operation control data in conformity with the acquired automated driving plan (Step 111), and to output the generated operation control data to the automated driving performing apparatus 20 (Step 112).

The image data receiver is configured to receive ROI-image information transmitted from the sensor apparatus 40, and to output the received information to the decoder. The decoder is configured to decode the ROI-image information, and to output information obtained by the decoding to the target object recognizing section 32.

“Sensor Apparatus”

(Sensor Block)

Next, the sensor block 47 of the sensor apparatus 40 is described. The central processor 49 of the sensor block 47 is configured to set a ROI cutout location on the basis of information regarding a ROI location that is included in a ROI acquisition request transmitted from the automated-driving control apparatus 30 (refer to Step 204). Further, the central processor 49 of the sensor block 47 is configured to output the set ROI cutout location to the ROI cutout section 50.

Further, the central processor 49 of the sensor block 47 is configured to modify a ROI cutout location on the basis of an amount of misalignment of a target object in a ROI image analyzed by the image analyzer 57 of the signal processing block 48 (refer to Steps 207 and 208). Furthermore, the central processor 49 of the sensor block 47 is configured to output the modified ROI cutout location to the ROI cutout section 50.

Further, the central processor 49 of the sensor block 47 is configured to adjust an amount of exposure performed with respect to the image sensor 43 on the basis of an amount of exposure performed when an image from which the ROI image is generated is captured, the ROI image being analyzed by the image analyzer 57 of the signal processing block.

The ROI cutout section 50 is configured to acquire an overall image from the image sensor 43, and to cut a portion corresponding to a ROI cutout location out of the overall image to generate a ROI image (refer to Step 205). Further, the ROI cutout section 50 is configured to output information regarding the generated ROI image to the encoder 52.

Further, the ROI cutout section 50 is configured to combine, when a plurality of ROI images is generated from an overall image, ROI images of the plurality of ROI images to generate a combining image, and to output the combining image to the encoder 52 as ROI-image information. The ROI cutout section 50 is configured to generate ROI-related information at this point (refer to Step 211), and to output the ROI-related information to the ROI analyzer 51.

The ROI analyzer 51 is configured to convert the ROI-related information acquired from the ROI cutout section 50 into ROI-related information for encoding, and to output the ROI-related information for encoding to the encoder 52.

The encoder 52 is configured to encode ROI-image information, and to output the encoded ROI-image information to the image data transmitter 53. Further, the encoder 52 is configured to encode, when there is ROI-related information for encoding, the ROI-related information for encoding, and to include the encoded ROI-related information for encoding in the encoded ROI-image information to output the encoded ROI-image information to the image data transmitter 53.

The image data transmitter 53 is configured to transmit the encoded ROI-image information to the signal processing block 48.

(Signal Processing Block)

Next, the signal processing block 48 in the sensor apparatus 40 is described. The image data receiver 59 is configured to receive encoded ROI-image information, and to output the received encoded ROI-image information to the decoder 60.

The decoder 60 is configured to decode encoded ROI-image information. Further, the decoder 60 is configured to output ROI-image information obtained by the decoding to the ROI image generator 56. Furthermore, the decoder 60 is configured to generate, when ROI-related information is included in ROI-image information (when ROI-image information is a combining image obtained by combining ROI images of a plurality of ROI images), ROI-related information for decoding, and to output the generated ROI-related information for decoding to the information extraction section 55.

The information extraction section 55 is configured to convert ROI-related information for decoding into ROI-related information, and to output the ROI-related information obtained by the conversion to the ROI image generator 56. The ROI image generator 56 is configured to separate, when ROI-image information is a combining image obtained by combining ROI images of a plurality of ROI images, the combining image into the respective ROI images on the basis of ROI-related information. Further, the ROI image generator 56 is configured to output the ROI image to the image analyzer 57.

The image analyzer 57 is configured to analyze a ROI image to determine an amount of misalignment of the target object in the ROI image (refer to Step 206), and to output the misalignment amount to the central processor 54. Further, the image analyzer 57 is configured to analyze a ROI image to determine an amount of exposure performed when an image from which the ROI image is generated is captured, and to output the exposure amount to the central processor 54. Furthermore, the image analyzer 57 is configured to output the ROI image to the image processor 58.

The image processor 58 is configured to perform image processing on a ROI image on the basis of image-processing-control information from the central processor 54 (refer to Step 212). Further, the image processor 58 is configured to output the ROI-image to the encoder.

The central processor 54 is configured to receive, from the automated-driving control apparatus 30, a ROI acquisition request that includes a ROI location, and to transmit the ROI acquisition request to the sensor block 47. Further, the central processor 54 is configured to transmit, to the sensor block 47, information regarding the alignment of a target object and information regarding an exposure amount that are obtained by analysis performed by the image analyzer 57.

Further, the central processor 54 is configured to output image-processing-control information to the image processor 58. For example, the image-processing-control information is information used to cause the image processor 58 to perform image processing such as a digital-gain process, white balancing, a look-up-table (LUT) process, a color-matrix conversion, defect correction, shooting correction, denoising, gamma correction, and demosaicing.

Further, the central processor 54 is configured to acquire complementary information from the sensor unit 42 in response to a complementary-information-acquisition request from the automated-driving control apparatus 30, and to transmit complementary information to the automated-driving control apparatus 30.

The encoder 61 is configured to encode ROI-image information, and to output the encoded ROI-image information to the image data transmitter 62. Further, the encoder 61 is configured to encode, when there is ROI-related information for encoding, the ROI-related information for encoding, and to include the encoded ROI-related information for encoding in the encoded ROI-image information to output the encoded ROI-image information to the image data transmitter 62.

The image data transmitter 62 is configured to transmit the encoded ROI-image information to the automated-driving control apparatus 30.

### Specific Block Configuration: Second Example

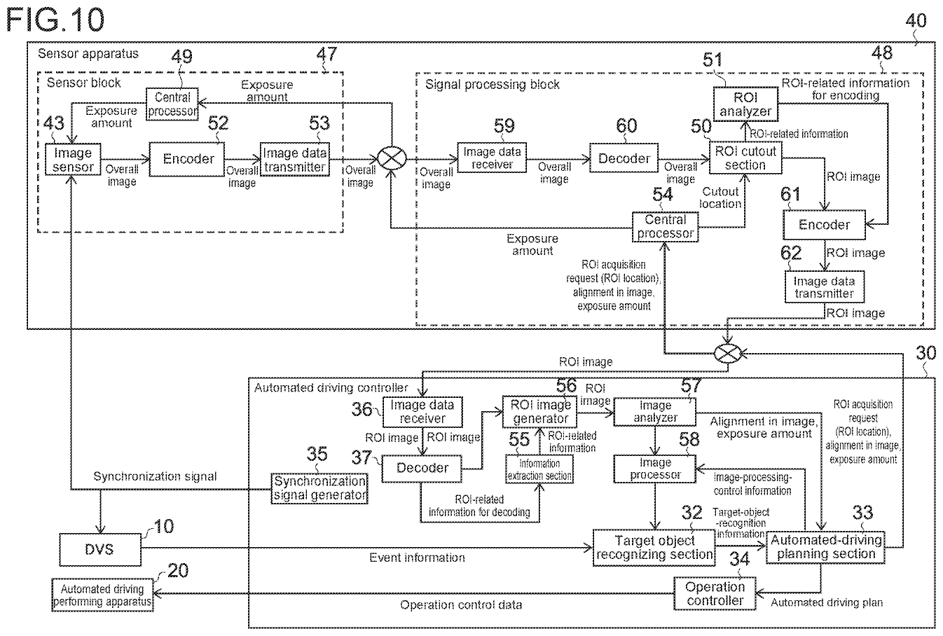

Next, another example of the specific block configuration in the automated-driving control system 100 is described. FIG. 10 illustrates another example of the specific block configuration in the automated-driving control system 100.

In the example illustrated in FIG. 10, the description is made focused on a point different from that in FIG. 9. The ROI cutout section 50 and the ROI analyzer 51 are provided to the sensor block 47 of the sensor apparatus 40 in the example illustrated in FIG. 9, whereas those are provided to the signal processing block 48 of the sensor apparatus 40 in the example illustrated in FIG. 10.

Further, the information extraction section 55, the ROI image generator 56, the image analyzer 57, and the image processor 58 are provided to the signal processing block 48 of the sensor apparatus 40 in the example illustrated in FIG. 9, whereas those are provided to the automated-driving control apparatus 30 in the example illustrated in FIG. 10.

Here, the controller 31 of the automated-driving control apparatus 30 in FIG. 2 corresponds to the synchronization signal generator 35, the target object recognizing section 32, the automated-driving planning section 33, the operation controller 34, the information extraction section 55, the ROI image generator 56, the image analyzer 57, and the image processor 58 in FIG. 10. Further, the controller 41 of the sensor apparatus 40 in FIG. 2 corresponds to the central processor 49 of the sensor block 47; and the central processor 49, the ROI cutout section 50, and the ROI analyzer 51 of the signal processing block 48 in FIG. 10.

In the example illustrated in FIG. 10, the image analyzer 57 and the image processor 58 are not provided on the side of the sensor apparatus 40, but is provided on the side of the automated-driving control apparatus 30. Thus, the determination of an amount of misalignment of a target object in a ROI image, the determination of an amount of exposure performed with respect to the image sensor 43, and the image processing on a ROI image are not performed on the sensor side, but are performed on the side of the automated-driving control apparatus 30. In other words, these processes may be performed on the side of the sensor apparatus 40 or on the side of the automated-driving control apparatus 30.

In the example illustrated in FIG. 10, a ROI image is not cut out by the sensor block 47, but is cut out by the signal processing block 48. Thus, not a ROI image, but an overall image is transmitted to the signal processing block 48 from the sensor block 47.

The signal processing block 48 is configured to receive an overall image from the sensor block 47, and to generate a ROI image corresponding to a ROI location from the overall image. Further, the signal processing block 48 is configured to output the generated ROI image to the automated-driving control apparatus 30 as ROI-image information.

Further, the signal processing block 48 is configured to generate ROI-related information and a combining image when a plurality of ROI images is generated from a single overall image, the combining image being obtained by combining ROI images of the plurality of ROI images. In this case, the signal processing block 48 is configured to use the combining image as ROI-image information, and to include the ROI-related information in the ROI-image information to transmit the ROI-image information to the automated-driving control apparatus 30.

In the example illustrated in FIG. 10, a portion of the processing performed by the central processor 49 of the sensor block 47 in the example illustrated in FIG. 9 is performed by the central processor 54 of the signal processing block 48.

In other words, the central processor 54 of the signal processing block 48 is configured to set a ROI cutout location on the basis of information regarding a ROI location that is included in a ROI acquisition request transmitted from the automated-driving control apparatus 30. Further, the central processor 54 of the signal processing block 48 is configured to output the set ROI cutout location to the ROI cutout section 50.

Further, the central processor 54 of the signal processing block 48 is configured to modify a ROI cutout location on the basis of an amount of misalignment of a target object in a ROI image analyzed by the image analyzer 57 of the automated-driving control apparatus 30. Then, the central processor 54 of the signal processing block 48 is configured to output the modified ROI cutout location to the ROI cutout section 50.

In the example illustrated in FIG. 10, the automated-driving control apparatus 30 is similar in essence to the automated-driving control apparatus 30 illustrated in FIG. 9 except that the information extraction section 55, the ROI image generator 56, the image analyzer 57, and the image processor 58 are added. However, in the example illustrated in FIG. 10, a portion of the processing performed by the central processor 54 of the signal processing block 48 in the sensor apparatus 40 in the example illustrated in FIG. 9 is performed by the automated-driving planning section 33 of the automated-driving control apparatus 30.

In other words, the automated-driving planning section 33 is configured to transmit, to the sensor apparatus 40, information regarding the alignment of a target object and information regarding an exposure amount that are obtained by analysis performed by the image analyzer 57. Further, the automated-driving planning section 33 is configured to output image-processing-control information to the image processor 58.

### Effects and Others

As described above, the present embodiment adopts an approach in which a ROI image is acquired by specifying, on the basis of event information from the DVS 10, a ROI location that corresponds to a target object that is necessary to design a driving plan, and the target object is recognized on the basis of the acquired ROI image.

In other words, instead of an overall image, a ROI image is acquired in the present embodiment in order to recognize a target object. Thus, the present embodiment has the advantage that an amount of data is smaller and thus it takes a shorter time to acquire an image, compared to when an overall image is acquired each time.

Further, a target object is recognized using a ROI image of which a data amount is reduced by ROI processing. Thus, the present embodiment has the advantage that it takes a shorter time to recognize a target object, compared to when an overall image is globally analyzed to recognize the target object. Furthermore, the present embodiment also makes it possible to recognize a target object accurately since the target object is recognized on the basis of a ROI image. In other words, the present embodiment makes it possible to recognize a target object quickly and accurately.

Note that processing of acquiring event information from the DVS 10 to specify a ROI location is added in the present embodiment, which is different from the case in which an overall image is acquired, and the overall image is globally analyzed to recognize a target object. Thus, in order to compare the times taken by both of the approaches to recognize a target object, there is a need to take into consideration the time taken to acquire event information and the time taken to specify a ROI location. However, event information is output by the DVS 10 at a high speed, as described above, and an amount of data of the event information is small. Thus, it also takes a shorter time to specify a ROI location that corresponds to a target object. Therefore, even in consideration of the points described above, the present embodiment in which a ROI image is acquired, and the ROI image is analyzed to recognize a target object, makes it possible to reduce the time necessary to recognize a target object, compared to when an overall image is acquired, and the overall image is analyzed to recognize the target object.

Further, the present embodiment makes it possible to design an automated driving plan on the basis of information regarding a target object quickly and accurately recognized on the basis of a ROI image. This results in being able to improve the safety and the reliability in automated driving.

Further, in the present embodiment, a ROI location is set on the basis of event information from the DVS 10. Consequently, an appropriate location, in leftward, rightward, upward, and downward directions, that corresponds to a target object can be cut out of each overall image to generate a ROI image.

Further, in the present embodiment, a ROI cutout location for a ROI image is modified on the basis of an amount of misalignment of a target object in the ROI image. This makes it possible to generate a ROI image obtained by cutting out a target object appropriately.

Further, in the present embodiment, when an automated driving plan is designable, without acquiring a ROI image, only using information regarding a target object recognized on the basis of event information from the DVS 10, the automated driving plan is designed only using this information.

Here, event information is output by the DVS 10 at a high speed, as described above, and an amount of data of the event information is small. Thus, for example, it takes a shorter time to recognize a target object, compared to when an overall image from the image sensor 43 is globally analyzed to recognize the target object. Thus, in, for example, an emergency such as the case in which another vehicle is likely to collide with the own vehicle 1, or the case in which the pedestrian 6 is likely to run in front of the own vehicle 1, an emergency event can be avoided by quickly designing a driving plan only using information regarding a target object recognized on the basis of event information.

Further, in the present embodiment, complementary information is acquired from a complementary sensor, and a target object is recognized on the basis of the complementary information. This also makes it possible to appropriately recognize a target object (such as the partition line 8 extending in parallel with the traveling own vehicle 1, or a target object that is no longer captured as a portion in which there is a change in brightness, due to the own vehicle 1 being stopped) that is not recognized on the basis of event information or a ROI image.

Further, the present embodiment makes it possible to design an automated driving plan on the basis of information regarding a target object accurately recognized on the basis of complementary information. This results in being able to further improve the safety and the reliability in automated driving.

Further, in the present embodiment, a period with which a target object is recognized on the basis of complementary information, is changed on the basis of information regarding a movement of the own vehicle 1. This makes it possible to appropriately change the period according to the movement of the own vehicle 1. In this case, when the period is made shorter as the movement of the own vehicle 1 becomes slower, this makes it possible to, for example, appropriately recognize, using complementary information, a target object that is not captured by the DVS 10 as a portion in which there is a change in brightness, due to the movement of the own vehicle 1 becoming slower.

### Various Modifications

The example in which a target-object-recognition technology according to the present technology is used to recognize a target object in an automated driving control has been described above. On the other hand, the target-object-recognition technology according to the present technology can also be used for a purpose other than the purpose of the automated driving control. For example, the target-object-recognition technology according to the present technology may be used to detect a product defect caused on a production line, or may be used to recognize a target object that is a superimposition target when augmented reality (AR) is applied. Typically, the target-object-recognition technology according to the present technology can be applied to any purpose of recognizing a target object.

The present technology may also take the following configurations.

(1) An information processing apparatus, including

a controller that
recognizes a target object on the basis of event information that is detected by an event-based sensor, and
transmits a result of the recognition to a sensor apparatus that includes a sensor section that is capable of acquiring information regarding the target object.
   (2) The information processing apparatus according to (1), in which

the controller
recognizes the target object,
specifies a region-of-interest (ROI) location that corresponds to the target object, and
transmits the ROI location to the sensor apparatus as the result of the recognition.
   (3) The information processing apparatus according to (2), in which

the sensor apparatus
cuts ROI information corresponding to the ROI location out of information that is acquired by the sensor section, and
transmits the ROI information to the information processing apparatus.
   (4) The information processing apparatus according to (3), in which

the controller recognizes the target object on the basis of the ROI information acquired from the sensor apparatus.

(5) The information processing apparatus according to (4), in which

the controller designs an automated driving plan on the basis of information regarding the target object recognized on the basis of the ROI information.

(6) The information processing apparatus according to (5), in which

the controller designs the automated driving plan on the basis of information regarding the target object recognized on the basis of the event information.

(7) The information processing apparatus according to (6), in which

the controller determines whether the automated driving plan is designable only on the basis of the information regarding the target object recognized on the basis of the event information.

(8) The information processing apparatus according to (7), in which

when the controller has determined that the automated driving plan is not designable,

the controller
acquires the ROI information, and
designs the automated driving plan on the basis of the information regarding the target object recognized on the basis of the ROI information.
   (9) The information processing apparatus according to (7) or (9), in which

when the controller has determined that the automated driving plan is designable,

the controller designs, without acquiring the ROI information, the automated driving plan on the basis of the information regarding the target object recognized on the basis of the event information.

(10) The information processing apparatus according to any one of (3) to (9), in which

the sensor section includes an image sensor that is capable of acquiring an image of the target object, and

the ROI information is a ROI image.

(11) The information processing apparatus according to any one of (5) to (10), in which

the sensor section includes a complementary sensor that is capable of acquiring complementary information that is information regarding a target object that is not recognized by the controller using the event information.

(12) The information processing apparatus according to (11), in which

the controller acquires the complementary information from the sensor apparatus, and

on the basis of the complementary information, the controller recognizes the target object not being recognized using the event information.

(13) The information processing apparatus according to (12), in which

the controller designs the automated driving plan on the basis of information regarding the target object recognized on the basis of the complementary information.

(14) The information processing apparatus according to (13), in which

the controller acquires information regarding a movement of a movable object, the movement being a target of the automated driving plan, and

on the basis of the information regarding the movement, the controller changes a period with which the target object is recognized on the basis of the complementary information.

(15) The information processing apparatus according to (14), in which

the controller makes the period shorter as the movement of the movable object becomes slower.

(16) The information processing apparatus according to any one of (3) to (15), in which

the sensor apparatus modifies a cutout location for the ROI information on the basis of an amount of misalignment of the target object in the ROI information.

(17) An information processing system, including:

an information processing apparatus that includes
a controller that
   recognizes a target object on the basis of event information that is detected by an event-based sensor, and
   transmits a result of the recognition to a sensor apparatus that includes a sensor section that is capable of acquiring information regarding the target object; and

the sensor apparatus.

(18) An information processing method, including:

recognizing a target object on the basis of event information that is detected by an event-based sensor; and

transmitting a result of the recognition to a sensor apparatus that includes a sensor section that is capable of acquiring information regarding the target object.

(19) A program that causes a computer to perform a process including:

recognizing a target object on the basis of event information that is detected by an event-based sensor; and

transmitting a result of the recognition to a sensor apparatus that includes a sensor section that is capable of acquiring information regarding the target object.

### REFERENCE SIGNS LIST

10 DVS
20 automated driving performing apparatus
30 automated-driving control apparatus
31 controller of automated-driving control apparatus
40 sensor apparatus
41 controller of sensor apparatus
42 sensor unit
43 image sensor
44 lidar
45 millimeter-wave radar
46 ultrasonic sensor
100 automated-driving control system

1. An information processing apparatus, comprising
a controller that
recognizes a target object on a basis of event information that is detected by an event-based sensor, and
transmits a result of the recognition to a sensor apparatus that includes a sensor section that is capable of acquiring information regarding the target object.

2. The information processing apparatus according to claim 1, wherein
the controller
recognizes the target object,
specifies a region-of-interest (ROI) location that corresponds to the target object, and
transmits the ROI location to the sensor apparatus as the result of the recognition.

3. The information processing apparatus according to claim 2, wherein
the sensor apparatus
cuts ROI information corresponding to the ROI location out of information that is acquired by the sensor section, and
transmits the ROI information to the information processing apparatus.

4. The information processing apparatus according to claim 3, wherein
the controller recognizes the target object on a basis of the ROI information acquired from the sensor apparatus.

5. The information processing apparatus according to claim 4, wherein
the controller designs an automated driving plan on a basis of information regarding the target object recognized on the basis of the ROI information.

6. The information processing apparatus according to claim 5, wherein
the controller designs the automated driving plan on a basis of information regarding the target object recognized on the basis of the event information.

7. The information processing apparatus according to claim 6, wherein
the controller determines whether the automated driving plan is designable only on the basis of the information regarding the target object recognized on the basis of the event information.

8. The information processing apparatus according to claim 7, wherein
when the controller has determined that the automated driving plan is not designable,
the controller
acquires the ROI information, and
designs the automated driving plan on the basis of the information regarding the target object recognized on the basis of the ROI information.

9. The information processing apparatus according to claim 7, wherein
when the controller has determined that the automated driving plan is designable,
the controller designs, without acquiring the ROI information, the automated driving plan on the basis of the information regarding the target object recognized on the basis of the event information.

10. The information processing apparatus according to claim 3, wherein
the sensor section includes an image sensor that is capable of acquiring an image of the target object, and
the ROI information is a ROI image.

11. The information processing apparatus according to claim 5, wherein
the sensor section includes a complementary sensor that is capable of acquiring complementary information that is information regarding a target object that is not recognized by the controller using the event information.

12. The information processing apparatus according to claim 11, wherein
the controller acquires the complementary information from the sensor apparatus, and
on a basis of the complementary information, the controller recognizes the target object not being recognized using the event information.

13. The information processing apparatus according to claim 12, wherein
the controller designs the automated driving plan on a basis of information regarding the target object recognized on the basis of the complementary information.

14. The information processing apparatus according to claim 13, wherein
the controller acquires information regarding a movement of a movable object, the movement being a target of the automated driving plan, and
on a basis of the information regarding the movement, the controller changes a period with which the target object is recognized on the basis of the complementary information.

15. The information processing apparatus according to claim 14, wherein
the controller makes the period shorter as the movement of the movable object becomes slower.

16. The information processing apparatus according to claim 3, wherein
the sensor apparatus modifies a cutout location for the ROI information on a basis of an amount of misalignment of the target object in the ROI information.

17. An information processing system, comprising:
an information processing apparatus that includes
a controller that
recognizes a target object on a basis of event information that is detected by an event-based sensor, and
transmits a result of the recognition to a sensor apparatus that includes a sensor section that is capable of acquiring information regarding the target object; and
the sensor apparatus.

18. An information processing method, comprising:
recognizing a target object on a basis of event information that is detected by an event-based sensor; and
transmitting a result of the recognition to a sensor apparatus that includes a sensor section that is capable of acquiring information regarding the target object.

19. A program that causes a computer to perform a process comprising:
recognizing a target object on a basis of event information that is detected by an event-based sensor; and
transmitting a result of the recognition to a sensor apparatus that includes a sensor section that is capable of acquiring information regarding the target object.
